(19) United States
(12) Patent Application Publication
(10) Pub. No.: US 2025/0051942 A1
(43) Pub. Date: Feb. 13, 2025

(54) A Separator for an Electrolytic Cell

(71) Applicant: Agfa-Gevaert NV, Mortsel (BE)

(72) Inventors: Hanne Verwaest, Mortsel (BE); Willem Mues, Mortsel (BE)

(73) Assignee: Agfa-Gevaert NV, Mortsel (BE)

(21) Appl. No.: 18/721,268

(22) PCT Filed: Dec. 20, 2022
(86) PCT No.: PCT/EP2022/086917

§ 371 Date: Jun. 18, 2024

(30) Foreign Application Priority Data
Dec. 21, 2021 (EP) 21216381.0

(51) Int. Cl. C25B 13/02; C08J 7/04; C25B 13/08

(52) U.S. Cl. CPC C25B 13/02; C08J 7/0427; C25B 13/08; C08J 2381/04; C08J 2381/06

(57) ABSTRACT

A separator for an electrolytic cell alkaline electrolysis (1) characterized in that the separator has a residual non-aqueous solvent amount of less than 5 wt %, relative to the total dry weight of the separator.

### TECHNICAL FIELD OF THE INVENTION

The present invention relates to a separator for an electrolytic cell and to a manufacturing method thereof.

### BACKGROUND ART FOR THE INVENTION

Nowadays, hydrogen is used in several industrial processes, for example its use as raw material in the chemical industry and as a reducing agent in the metallurgic industry. Hydrogen is a fundamental building block for the manufacture of ammonia, and hence fertilizers, and of methanol, used in the manufacture of many polymers. Refineries, where hydrogen is used for the processing of intermediate oil products, are another area of use. However, the production of hydrogen from fossil fuels results in massive CO2 emission.

Hydrogen is also being considered an important future energy carrier, which means it can store and deliver energy in a usable form. Energy is released by an exothermic combustion reaction with oxygen thereby forming water. During such combustion reaction, no greenhouse gases containing carbon are emitted.

For the realization of a low-carbon society, renewable energies using natural energy such as solar light and wind power are becoming more and more important.

The production of electricity from wind power and solar power generation systems is very much dependent on the weather conditions and therefore variable, leading to an imbalance of demand and supply of electricity. To store surplus electricity, the so-called power-to-gas technology wherein electrical power is used to produce gaseous fuel such as hydrogen, attracted much interest in recent years. As production of electricity from renewable energy sources will increase, the demand for storage and transportation of the produced energy will also increase.

Water electrolysis is an important manufacturing process wherein electricity may be converted into hydrogen. Hydrogen produced in this way is often referred to as green hydrogen, emphasizing that no greenhouse gases are formed during its production. Ammonia and steel prepared from or with green hydrogen are also referred to as green ammonia and green steel.

In a water electrolysis cell, a so-called separator or diaphragm is used to separate electrodes of different polarity to prevent a short circuit between these electrodes and to prevent the recombination of hydrogen (formed at the cathode) and oxygen (formed at the anode) by avoiding gas crossover. In addition, the separator should also be a highly ionic conductor for transportation of ions from one electrode to the other.

A separator is typically mounted in a frame thereby forming a so-called separator element. That separator element is then introduced in the electrolytic cell separating the anode and the cathode.

To prevent gas cross over it is important that the separator does not have any physical defects, such as for example cracks.

### SUMMARY OF THE INVENTION

It is an object of the invention to provide a separator having improved mechanical/physical properties when introduced in an electrolytic cell.

This object is realized with a separator as defined in claim 1.

It has been observed that the residual amount of non-aqueous solvents in a separator has an influence on the amount of cracks in the separator.

Also, it has been observed that a separator mounted in a frame may shrink when introduced in an electrolytic cell. Such shrinkage may introduce defects in the mounted separator, such as cracks, resulting in all sorts of problems during electrolysis, such as decrease of the ionic conductivity or an increasing gas crossover. It has now also been observed that a residual amount of non-aqueous solvents in the separator has also an influence on the shrinking properties of the membrane.

It is another object of the invention to provide a method of preparing such a separator.

Further objects of the invention will become apparent from the description hereinafter.

### BRIEF DESCRIPTION OF THE DRAWINGS

FIG. 1 shows schematically an embodiment of a separator according to the present invention.

FIG. 2 shows schematically another embodiment of a separator according to the present invention.

FIG. 3 shows schematically some examples of a pore diameter distribution in the thickness direction of a separator.

FIG. 4 shows schematically an embodiment of a manufacturing method of a separator as shown in FIG. 2.

FIG. 5 shows schematically another embodiment of a manufacturing method of a separator as shown in FIG. 2.

FIG. 6 shows schematically an embodiment of an electrolytic cell according to the present invention.

### DETAILED DESCRIPTION OF THE INVENTION Separator

The separator (1) according to the present invention comprises less than 5 wt %, preferably less than 3.5 wt %, more preferably less than 2.5 wt %, most preferably less than 1 wt % of a residual non-aqueous solvent, all relative to the total dry weight of the separator.

The residual non-aqueous solvent amount is preferably more than 0.05 wt %, more preferably more than 0.1 wt %, most preferably more than 0.5 wt %, all relative to the total dry weight of the separator.

A separator is also referred to herein as a membrane or as a diaphragm.

The residual non-aqueous solvent amount is preferably determined as described below in the examples.

It has now been observed that the amount of residual non-aqueous solvent in a separator, as referred to above, has an influence on the physical properties of the separator, for example the amount of cracks.

The non-aqueous solvent referred to is typically a solvent used in the manufacturing method of the separator described below, for example solvents used in the dope solution, in particular the solvents used in the dope solution to dissolve the polymer. During the phase transfer step and/or washing step of the manufacturing method as described in more detail below, such solvents are at least partially removed from the separator by diffusion into the coagulation bath and/or washing bath. However, depending on:
the residence time of the membrane in these baths,
the temperature of these baths,
the amount of solvents in the separator before entering these baths, and.
the amount of solvents already present in these baths,
   the obtained separator may still contain some non-aqueous solvent, referred to herein as residual non-aqueous solvent amount.

For example, it has been observed that when already a substantial amount of separator has been prepared, the residual non-aqueous solvent amount in the separator may increase because the concentration of non-aqueous solvents in the coagulating and washing bath increases. To keep the residual non-aqueous solvent amount in the obtained separator under control it may be necessary to change the coagulation and washing baths on a regular basis or the replenish these baths.

The separator (1) preferably has an irreversible shrinkage, measured as described below, of less than 2.5%, preferably less than 1.5% or less, more preferably less than 1%, most preferably less than 0.5 wt %. It has been observed that the amount of residual non-aqueous solvent in the separator, referred to above, also has an influence on the irreversible shrinkage of the separator.

The separator is preferably used in a so-called alkaline water electrolytic cell as described below.

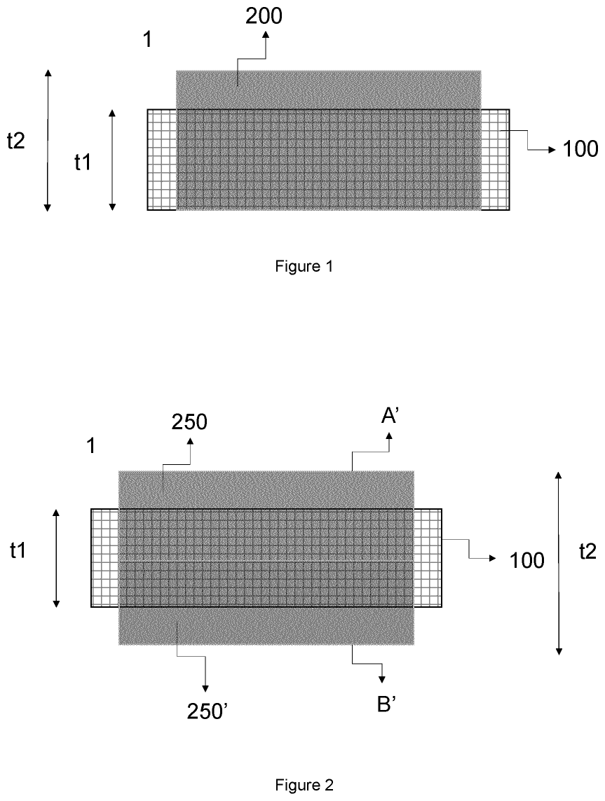

A preferred separator (1) comprises a porous support (100) and a porous layer (200) provided on a side of the porous support (see FIG. 1). The porous layer (200) is preferably provided on a side of a porous support as described below.

FIG. 2 schematically depicts another preferred separator wherein a first (250) and a second (250′) porous layer is provided on a porous support (100). The first (250) and second (250′) porous layers may be identical or different from each other. The porous layers are preferably provided on the support as described below.

The thickness of the separator (12) is preferably from 50 to 750 μm, more preferably from 75 to 500 μm, most preferably from 100 to 250 μm, particularly preferred from 125 to 200 μm. Increasing the thickness of the separator typically results in a higher physical strength of the separator. However, increasing the thickness of the separator typically also results in a decrease of the electrolysis efficiency due to an increase of the ionic resistance.

The separator preferably has an ionic resistance at 80° C. in a 30 wt % aqueous KOH solution of 0.1 ohm·cm² or less, more preferably of 0.07 ohm·cm² or less. The ionic resistance may be determined with an Inolab® Multi 9310 IDS apparatus available from VWR, part of Avantor, equipped with a TetraCon 925 conductivity cell available from Xylem.

As described below in more detail a separator according to the present invention is preferably prepared by the application of a coating solution, also referred to herein as a dope solution, on one or both sides of a porous support.

The dope solution preferably comprises a polymer, inorganic particles and a solvent. The residual non-aqueous solvent referred to above is preferably the solvent used in the dope solution.

A porous layer is then obtained after a phase inversion step wherein the polymer resin forms a three-dimensional porous polymer network.

Upon application of the dope solution(s) on one or both sides of the porous support, the dope solution(s) preferably impregnate the porous support. The porous support is more preferably completely impregnated with the dope solution(s). Such impregnation of the dope solution(s) into the porous support ensures that after phase inversion the three-dimensional porous polymer network also extends into the porous support, resulting in an improved adhesion between the porous layer and the porous support.

The separator includes pores having a pore diameter that is sufficiently small to prevent recombination of hydrogen and oxygen by avoiding gas crossover in the longitudinal direction of the separator. On the other hand, to ensure efficient transportation of hydroxyl ions from the cathode to the anode the pore diameter may not be too small to ensure an efficient penetration of electrolyte into the separator.

The pores are preferably characterized using the Bubble Point Test method described in American Society for Testing and Materials Standard (ASMT) Method F316. This technique is based on the displacement of a wetting liquid embedded in the separator by applying an inert pressurised gas. Only through-pores are measured in this way. The most challenging part for the gas to displace the liquid along the entire pore path is the most constricted section of the pore, also known as pore throat. The diameter of a pore measured with the Bubble Point Test method is the diameter of that pore throat, regardless of where the pore throat is positioned in the pore path.

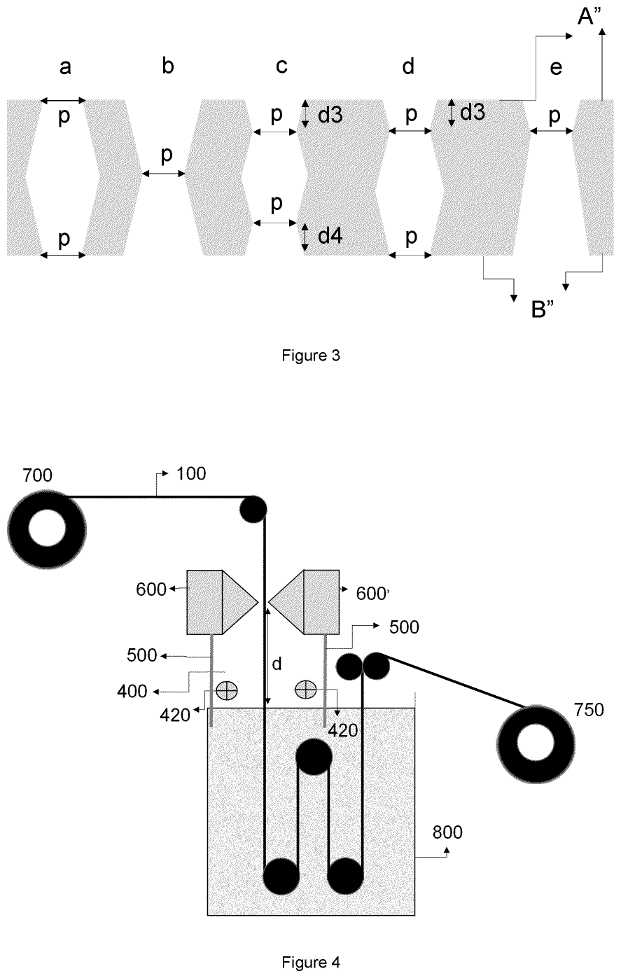

FIG. 3 schematically depicts so called through-pores a to e having various shapes. Through-pores referred to herein are pores that enables transport from one side to the separator to the other side of the separator. The pore throat (p) is shown for the different pore shapes.

For clarity reasons the porous support and porous layer(s) of the separator are not separately shown in FIG. 3. The separator in FIG. 3 may be the separator shown in FIG. 1 or FIG. 2.

The pore throat may be situated:
at the outer surface(s) of the separator of the separator (a);
“inside” the separator (b, c, e); or
both at an outer surface of the separator and “inside” the separator (d).

According to a preferred embodiment, the pore throat is situated at a distance d3 and/or d4 from one or both outer surfaces of the separator. The distances d3 and d4 may be identical or different from each other. The distances d3 and d4 are preferably from 0 to 15 μm, more preferably from 0 to 10 μm from respectively the outer surfaces A″ and B″ of the separator.

The pore diameter at both outer surfaces may be substantially identical or different from each other. Substantially identical referred to herein means that a ratio of the pore diameter of both surfaces is from 0.9 to 1.1.

Pore diameters at the outer surface of a separator may also be measured with Scanning Electrode Microscopy (SEM) as disclosed in EP-A 3652362. For a pore shape (a) in FIG. 3 the pore diameter measured with SEM at the outer surfaces of the separator will correspond with the maximum pore diameter PDmax measured with the Bubble Point Test method. When a pore throat is however situated inside the separator (see pore shapes (b), (c), (d) and (e) in FIG. 3) the maximum pore diameter (PDmax) measured with the Bubble Point Test method will be smaller compared to the pore diameter measured at the outer surfaces with SEM.

The Bubble Point Test method may be adapted to measure a maximum pore diameter (PDmax) on both sides of a separator by using a grid supporting one side of the separator during the measurement. Another measurement is then carried out using the grid supporting to other side of the separator.

The PDmax measured for both sides of the separator may be substantially identical or different from each other.

A preferred separator has a maximum pore diameter PDmax (1) on one side and a maximum pore diameter PDmax (2) on the other side wherein both PDmax (1) and PDmax (2) are from 0.05 to 2 μm, more preferred from 0.10 to 1 μm, most preferred from 0.2 to 0.6 μm and wherein the ratio PDmax (1)/PDmax (2) is from 0.9 to 1.1, more preferred from 0.95 to 1.05.

Another preferred separator of which both sides have different pore diameters measured with the Bubble Point Test method is disclosed in EP-A 3652362. The maximum pore diameter of a first porous layer PDmax (1) is preferably from 0.05 to 0.3 μm, more preferably from 0.08 to 0.25 μm, most preferably from 0.1 to 0.2 μm and the maximum pore diameter of a second porous layer PDmax (2) is preferably from 0.1 to 6.5 μm, more preferably from 0.15 to 1.50 μm, most preferably from 0.2 to 0.5 μm. The ratio PDmax (2)/PDmax (1) is preferably from 1.1 to 20, more preferably from 1.25 to 10, most preferably from 2 to 7.5. The smaller PDmax (1) ensure an efficient separation of hydrogen and oxygen while PDmax (2) ensures a good penetration of the electrolyte in the separator resulting in a sufficient ionic conductivity.

The porosity of the separator is preferably from 30 to 70%, more preferably from 40 to 60%. A separator having a porosity within the above ranges typically has excellent ion permeability and excellent gas barrier properties because the pores of the separator are continuously filled with an electrolyte solution. A porosity of 80% or higher would result in a too low mechanical strength of the separator and a too high permeation of electrolyte, the latter resulting in an increase of the HTO (wt % hydrogen present in the oxygen formed at the anode).

The separator preferably has a water permeability from 200 to 800 l/bar·h·m², more preferably from 300 to 600 l/bar·h·m².

It has been observed that the water content of a manufactured separator may influence its mechanical properties.

Preferably at least 25 volume percent, more preferably at least 40 volume percent, most preferably at least 50 volume % of the pores of the separator are filled with water. In a particularly preferred embodiment, at least 75 volume % of the pores are filled with water.

The volume % of the pores that are filled with water (Vol % P) is determined by the method described below.

### Porous Support

The porous support is used to reinforce the separator to ensure its mechanical strength.

A thickness of the porous support (t1) is preferably 350 μm or less, more preferably 200 μm or less, most preferably 100 μm or less, particularly preferred 75 μm or less.

It has been observed that the ion conductivity through a reinforced separator increases when the thickness of the porous support decreases.

However, to ensure sufficient mechanical properties of the reinforced separator, the thickness of the porous support is preferably 20 μm or more, more preferably 40 μm or more.

The porous support may be selected from the group consisting of a porous fabric and a porous ceramic plate.

The porous support is preferably a non-woven fabric, a woven fabric, a mesh or a felt, more preferably a non-woven or woven fabric.

Woven fabrics typically have a better dimensional stability and homogeneity of open area and thickness. However, the manufacture of woven fabrics with a thickness of 100 μm or less is more complex resulting in more expensive fabrics. The manufacture of non-woven fabrics is less complex, even for fabrics having a thickness of 100 μm or less. Also, non-woven fabrics may have a larger open area.

The open area of the porous support is preferably between 30 and 80%, more preferably between 40 and 70%, to ensure a good penetration of the electrolyte into the support.

The fabric preferably has a fibre diameter from 20 μm to 200 μm, more preferably from 40 μm to 150 μm, most preferably from 60 μm to 100 μm. Fabrics having a lower thickness t1 preferably have a smaller fibre diameter. For example a fabric having a thickness t1 of 150 μm or lower preferably have a fibre diameter of 75 μm or lower, more preferably of 50 μm or lower, most preferably of 35 μm or lower.

To further reduce the thickness t1 of the fabric, the ratio of the gauze thickness to the fibre diameter is preferably less than 2.0, more preferably 1.7 or less, most preferably 1.4 or less. A thinner fabric makes it possible to prepare thinner separators.

The porous support preferably includes a polymer such as polypropylene, polyethylene, polysulfone, polyphenylene sulfide, polyamide/nylon, polyether sulfone, polyphenyl sulfone, polyethylene terephthalate, polyether-ether ketone, sulfonated polyether-ether keton, monochlorotrifluoroethylene, copolymers of ethylene with tetrafluorethylene or chlorotrifluorethylene, polyimide, polyether imide and m-aramide.

A preferred porous support includes polyphenylene sulphide (PPS) or polyether ether ketone (PEEK).

A PPS or PEEK based porous support has a high resistance to high-temperature, high concentration alkaline solutions and a high chemical stability against active oxygen evolved from an anode during the water electrolysis process. Also, PPS and PEEK can be easily processed into various forms such as a woven fabric or a non-woven fabric.

The density of the porous support is preferably between 0.1 to 0.7 g/cm³.

The porous support is preferably a continuous web to enable a manufacturing process as disclosed in EP-A 1776490 and WO2009/147084.

The width of the web is preferably between 30 and 300 cm, more preferably between 40 and 200 cm.

A preferred porous substrate has a sufficient dimensional stability, for example a minimal irreversible shrinkage. Such an improved dimensional stability may be realized by applying a heat setting treatment at the end of the manufacturing process of the porous substrate. A woven fabric is typically washed and dried as it comes out of the loom. Then, a heat setting treatment is preferably carried out. The heat setting treatment may be carried out in either a steam atmosphere or a dry environment. The temperature during heat setting is preferably from 50 to 250° C., more preferably from 100 to 200° C.

The irreversible shrinkage in both the warp and the weft direction of a woven fabric used as porous support for the separator according to the present invention is preferably 5% or less, more preferably 2.5% or less, most preferably 1 w % or less, particular preferred 0.5% or less. The irreversible shrinkage of the fabric may also be measured according to the method described below.

### Polymer

The porous layer preferably comprises a polymer.

The polymer forms a three dimensional porous network, the result of a phase inversion step in the preparation of the separator, as described below.

The polymer may be selected from a fluorine resin such as polyvinylidene fluoride and polytetrafluoroethylene, an olefin resin such as polypropylene, and an aromatic hydrocarbon resin such as polyethylene terephthalate and polystyrene. The polymer resins may be used alone, or two or more of the polymer resins may be used in combination.

Polyvinylidene fluoride and vinylidenefluoride copolymers are preferred for their oxidation/reduction resistance and film-forming properties. Among these, terpolymers of vinylidenefluoride, hexanefluoropropylene and chlorotrifluoroethylene are preferred for their excellent swelling properties, heat resistance and adhesion to electrodes.

Another preferred polymer is an aromatic hydrocarbon resin for their excellent heat and alkali resistance. Examples of an aromatic hydrocarbon resin include polyethylene terephthalate, polybutylene terephthalate, polybutylene naphthalate, polystyrene, polysulfone, polyethersulfone, polyphenylene sulfide, polyphenyl sulfone, polyacrylate, polyetherimide, polyimide, and polyamide-imide.

A particular preferred polymer is selected from the group consisting of polysulfone, polyethersulfone, polyphenylenesulfone, polyether ether ketone and polyphenylenesulfide, polysulfone being the most preferred.

When the temperature of the electrolyte in the electrolytic cell is high, for example more than 100° C., more than 115° C., more than 130° or even more than 145° C. it is preferred to use polyphenylene sulphide (PPS), polyphenylene sulfone (PPSU) or polyether ether ketone (PEEK). At suicch

The molecular weight (Mw) of the polymer is preferably between 10 000 and 500 000, more preferably between 25 000 and 250 000. When the Mw is too low, the physical strength of the porous layer may become insufficient. When the Mw is too high, the viscosity of the dope solution may become too high.

Examples of polysulfones, polyether sulfones and combinations thereof are disclosed in EP-A 3085815, paragraphs to [0032].

The amount of polymer is preferably from 5 to 40 wt %, more preferably from 10 to 30 wt %, most preferably from 15 to 25 wt %, all relative to the total dry weight of the porous layer.

### Inorganic Particles

The porous layer preferably comprises inorganic particles. The inorganic particles render the porous layer hydrophilic. The hydrophilic nature of the porous layer prevents the adhesion of hydrogen and oxygen bubbles. Such adhesion of gas bubbles would reduce the electrolysis efficiency.

Preferred inorganic particles are selected from metal oxides and metal hydroxides.

Preferred metal oxides are selected from the group consisting of zirconium oxide, titanium oxide, bismuth oxide, cerium oxide and magnesium oxide.

Preferred metal hydroxides are selected from the group consisting of zirconium hydroxide, titanium hydroxide, bismuth hydroxide, cerium hydroxide and magnesium hydroxide. A particularly preferred magnesium hydroxide is disclosed in EP-A 3660188, paragraphs to [0063].

Other preferred inorganic particles are sulfates of calcium, barium, lead or strontium, barium sulfate particles being more preferred.

Still other inorganic particles that may be used are nitrides and carbides of Group IV elements of the periodic table.

A combination of one or more different inorganic particles may be used.

The inorganic particles may be natural substances or synthetic substances.

The surface of the inorganic particles may be untreated or may be surface-treated with for example a silane coupling agent, stearic acid, oleic acid, or a phosphoric acid ester.

The shape of the inorganic particles is not particularly limited as long as it is in the form of particles and may be any of irregular shapes, spherical shapes such as true spherical shapes and oblong spherical shapes, plate shapes such as flake shapes and hexagonal plate shapes, and fibrous shapes.

The inorganic particles preferably have an aspect ratio from 1.0 to 8.0, more preferably from 1.5 to 7.0, most preferably from 2.0 to 6.0.

The inorganic particles preferably have a D₅₀ particle size from 0.05 to 2.0 μm, more preferably from 0.1 to 1.5 μm, most preferably from 0.15 to 1.00 μm, particularly preferred from 0.2 to 0.75 μm. The D₅₀ particle size is preferably 0.7 μm or less, more preferably 0.55 μm or less, most preferably 0.40 μm or less.

The D₅₀ particle size is also known as the median diameter or the medium value of the particle size distribution. It is the value of the particle diameter at 50% in the cumulative distribution. For example, if D₅₀=1.0 μm, then 50% of the particles are larger than 1.0 μm and 50% are smaller than 1.0 μm.

The D₅₀ particle size is preferably measured using laser diffraction, for example using a Mastersizer from Malvern Panalytical.

The amount of inorganic particles is preferably from 30 to 95 wt %, more preferably from 50 to 92 wt %, most preferably from 60 to 90 wt %, all relative to the total dry weight of the porous layer. The amount of inorganic particles is preferably at least 65 wt %, more preferably at least 75 wt %, all relative to the total dry weight of the porous layer.

The weight ratio of hydrophilic particles to polymer resin is preferably 60/40 or more, more preferably 70/30 or more, most preferably 75/25 or more.

### Preparation of the Separator

A preferred method of preparing a separator according to the present invention comprises the steps of:
applying a dope solution as described below on a side of a porous support (100);
performing phase inversion on the applied dope solution thereby forming a separator comprising a porous layer (200) on the support.

The applied dope solution preferably completely impregnates the porous support before performing the phase inversion.

A preferred method of manufacturing a reinforced separator is disclosed in EP-A 1776490 and WO2009/147084 for symmetric separators and EP-A 3652362 for asymmetric separators. These methods result in web-reinforced separators wherein the web, i.e. the porous support, is nicely embedded in the separator, without appearance of the web at a surface of the separator.

Other manufacturing methods that may be used are disclosed in EP-A 3272908, EP-A 3660188 and EP-A 3312306.

The amount of residual solvent may be reduced by carrying out a washing step after the phase inversion step.

The washing step is preferably carried out immediately after the phase separator step. However, the washing step may also been carried out at a later stage, for example before mounting the separator in an electrolyser.

A preferred method of preparing a separator according to the present invention comprises the steps of:
applying a dope solution as described below on a side of a porous support (100);
performing phase inversion on the applied dope solution thereby forming a separator comprising a porous layer (200) on the support; and
carrying out a washing step on the separator.

The washing step is preferably carried out in a water bath kept at a temperature of at least 60° C., more preferably at least 70° C., most preferably at least 80° C., particularly preferred at least 85° C.

The duration of the washing step is preferably from 5 to 90 minutes, more preferably from 10 minutes to 60 minutes, most preferably from 20 minutes to 40 minutes. The duration of the washing step may also be longer than 90 minutes but then the manufacturing method becomes less efficient.

### Dope Solution

The dope solution preferably comprises a polymer as described above, inorganic particles as described above and a solvent.

The solvent of the dope solution is preferably an organic solvent wherein the polymer can be dissolved. Moreover, the organic solvent is preferably miscible in water.

The solvent is preferably selected from N-methyl-pyrrolidone (NMP), N-ethyl-pyrrolidone (NEP), N-butyl-pyrrolidone (NBP), N,N-dimethyl-formamide (DMF), formamide, dimethylsulfoxide (DMSO), N,N-dimethyl-acetamide (DMAC), acetonitrile, and mixtures thereof.

A highly preferred solvent, for health and safety reasons, is N-butyl-pyrrolidone (NBP).

The residual non-aqueous solvent referred to above preferably includes the solvent used in the dope solution.

The dope solution may further comprise other ingredients to optimize the properties of the obtained polymer layers, for example their porosity and the maximum pore diameter at their outer surface.

The dope solution preferably comprises an additive to optimize the pore size at the surface and inside of the porous layer. Such additives may be organic or inorganic compounds, or a combination thereof.

Organic compounds which may influence the pore formation in the porous layers include polyethylene glycol, polyethylene oxide, polypropylene glycol, ethylene glycol, tripropylene glycol, glycerol, polyhydric alcohols, dibutyl phthalate (DBP), diethyl phthalate (DEP), diundecyl phthalate (DUP), isononanoic acid or neo decanoic acid, polyvinylpyrrolidone, polyvinyl-alcohol, polyvinylacetate, polyethyleneimine, polyacrylic acid, methylcellulose and dextran.

Preferred organic compounds which may influence the pore formation in the porous layers are selected from polyethylene glycol, polyethylene oxide and polyvinylpyrrolidone.

A preferred polyethylene glycol has a molecular weight of from 10 000 to 50 000, a preferred polyethylene oxide has a molecular weight of from 50 000 to 300 000, and a preferred polyvinylpyrrolidone has a molecular weight of from 30 000 to 1 000 000.

A particularly preferred organic compound which may influence the pore formation in the porous layers is glycerol.

The amount of compounds which may influence the pore formation is preferably from 0.1 and 15 wt %, more preferably from 0.25 and 10 wt %, most preferably from 0.5 to 2.5 wt %, all relative to the total weight of the dope solution.

Inorganic compounds which may influence the pore formation include calcium chloride, magnesium chloride, lithium chloride and barium sulfate.

A combination of two or more additives that influence the pore formation may be used.

The dope solutions provided on either side of the porous support may be the same or different.

### Applying the Dope Solution

The dope solution may be applied on the surface of a substrate, preferably a porous support, by any coating or casting technique.

A preferred coating technique is extrusion coating.

In a highly preferred embodiment, the dope solutions are applied by a slot die coating technique wherein two slot coating dies (FIGS. 4 and 5, 600 and 600′) are located on either side of a porous support.

The slot coating dies are capable of holding the dope solution at a predetermined temperature, distributing the dope solutions uniformly over the support, and adjusting the coating thickness of the applied dope solutions.

The viscosity of the dope solutions measured at a shear rate of 100 s⁻¹ and a temperature of 20° C. is at least 7.5 Pa·s, more preferably at least 15 Pa·s, most preferably at least 30 Pa·s.

The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

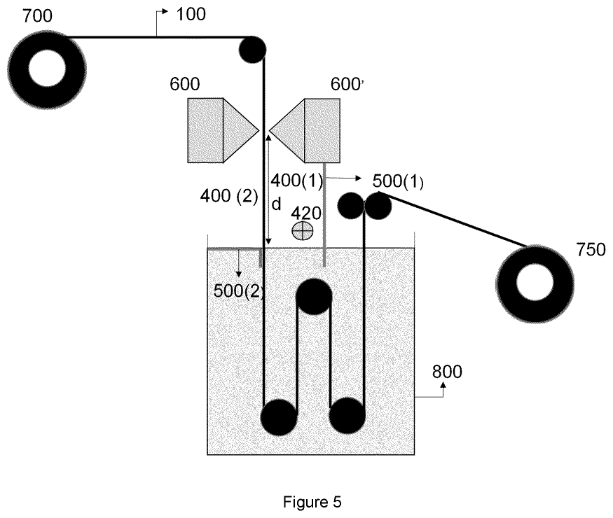

The porous support is preferably a continuous web, which is transported downwards between the slot coating dies (600, 600′) as shown in FIGS. 4 and 5.

Immediately after the application, the porous support becomes impregnated with the dope solutions.

Preferably, the porous support becomes fully impregnated with the applied dope solutions.

### Phase Inversion Step

After applying the dope solution onto a porous support, the applied dope solution is subjected to phase inversion. In the phase inversion step, the applied dope solution is transformed into a porous hydrophilic layer.

In a preferred embodiment, both dope solutions applied on a porous support are subjected to phase inversion.

Any phase inversion mechanism may be used to prepare the porous hydrophilic layers from the applied dope solutions.

The phase inversion step preferably includes a so-called Liquid Induced Phase Separation (LIPS) step, a Vapour Induced Phase Separation (VIPS) step or a combination of a VIPS and a LIPS step. The phase inversion step preferably includes both a VIPS and a LIPS step.

Both LIPS and VIPS are non-solvent induced phase-inversion processes.

In a LIPS step the porous support coated on both sides with the dope solution is contacted with a non-solvent that is miscible with the solvent of the dope solution.

Typically, this is carried out by immersing the porous support coated on both sides with the dope solutions into a non-solvent bath, also referred to as coagulation bath.

The non-solvent is preferably water, mixtures of water and an aprotic solvent selected from the group consisting of N-methylpyrrolidone (NMP), N-ethyl-pyrrolidone (NEP), N-butylpyrrolidone (NBP), dimethylformamide (DMF), dimethylsulfoxide (DMSO) and dimethylacetamide (DMAC); water solutions of water-soluble polymers such as PVP or PVA; or mixtures of water and alcohols, such as ethanol, propanol or isopropanol.

The temperature of the coagulation bath is preferably between 2° and 90° C., more preferably between 4° and 70° C.

The transfer of solvent from the coated polymer layer towards the non-solvent bath and of non-solvent into the polymer layer leads to phase inversion and the formation of a three-dimensional porous polymer network. The impregnation of the applied dope solution into the porous support results in a sufficient adhesion of the obtained hydrophilic layers onto the porous support.

In a preferred embodiment, the continuous web (100) coated on either side with a dope solution is transported downwards, in a vertical position, towards the coagulation bath (800) as shown in FIGS. 4 and 5.

In a VIPS step, the porous support coated with the dope solutions is exposed to non-solvent vapour, preferably humid air.

Preferably, the coagulation step included both a VIPS and a LIPS step. Preferably the VIPS step is carried out before the LIPS step. In a particular preferred embodiment, the porous support coated with the dope solutions is first exposed to humid air (VIPS step) prior to immersion in a water bath (LIPS step).

In the manufacturing method shown in FIG. 4, VIPS is carried out in the area 400, between the slot coating dies (600, 600′) and the surface of the non-solvent in the coagulation bath (800), which is shielded from the environment with for example thermal isolated metal plates (500).

The extent and rate of water transfer in the VIPS step can be controlled by adjusting the velocity of the air, the relative humidity and temperature of the air, as well as the exposure time.

The exposure time may be adjusted by changing the distance d between the slot coating dies (600, 600′) and the surface of the non-solvent in the coagulation bath (800) and/or the speed with which the elongated web 100 is transported from the slot coating dies towards the coagulation bath.

The relative humidity in the VIPS area (400) may be adjusted by the temperature of the coagulation bath and the shielding of the VIPS area (400) from the environment and from the coagulation bath.

The speed of the air may be adjusted by the rotating speed of the ventilators (420) in the VIPS area (400).

The VIPS step carried out on one side of the separator and on the other side of the separator, resulting in the second porous polymer layer, may be identical (FIG. 4) or different (FIG. 5) from each other.

After the phase inversion step, or the optional washing step, a drying step may be carried out.

### Manufacturing of the Separator

FIGS. 4 and 5 schematically illustrates a preferred embodiment to manufacture a separator according to the present invention.

The porous support is preferably a continuous web (100).

The web is unwinded from a feed roller (700) and guided downwards in a vertical position between two coating units (600) and (600′).

With these coating units, a dope solution is coated on either side of the web. The coating thickness on either side of the web may be adjusted by optimizing the viscosity of the dope solutions and the distance between the coating units and the surface of the web. Preferred coating units are described in EP-A 2296825, paragraphs [0043], [0047], [0048], [0060], [0063], and FIG. 1.

The web coated on both sides with a dope solution is then transported over a distance d downwards towards a coagulation bath (800).

In the coagulation bath, the LIPS step is carried out.

The VIPS step is carried out before entering the coagulation bath in the VIPS areas. In FIG. 4, the VIPS area (400) is identical on both sides of the coated web, while in FIG. 5, the VIPS areas (400(1)) and (400(2)) on either side of the coated web are different.

The relative humidity (RH) and the air temperature in de VIPS area may be optimized using thermally isolated metal plates. In FIG. 4, the VIPS area (400) is completely shielded from the environment with such metal plates (500). The RH and temperature of the air is then mainly determined by the temperature of the coagulation bath. The air speed in the VIPS area may be adjusted by a ventilator (420).

In FIG. 5 the VIPS areas (400(1)) and (400(2)) are different from each other. The VIPS area (400(1)) on one side of the coated web including a metal plate (500(1)) is identical to the VIPS area (400) in FIG. 4. The VIPS area (400(2)) on the other side of the coated web is different from the area (400(1)). There is no metal plate shielding the VIPS area (400(2)) from the environment. However, the VIPS area (400(2)) is now shielded from the coagulation bath by a thermally isolated metal plate (500(2)). In addition, there is no ventilator present in the VIPS area 400(2). This results in a VIPS area (400(1)) having a higher RH and air temperature compared to the RH and air temperature of the other VIPS area (400(2)).

A high RH and/or a high air speed in a VIPS area typically result in a larger maximum pore diameter.

The RH in one VIPS area is preferably above 85%, more preferably above 90%, most preferably above 95% while the RH in another VIPS area is preferably below 80%, more preferably below 75%, most preferably below 70%.

After the phase separation step, the reinforced separator is then transported to a rolled up system (750).

A liner may be provided on one side of the separator before rolling up the separator and the applied liner.

### Packaging

It has been observed that the water content of a manufactured separator may influence its mechanical properties. Therefore, a preferred packaging ensures that the water content remains substantially constant, even when the packaged membranes are stored for months at varying temperatures and/or relative humidities.

The separator is typically cut in sheets of varying dimensions and a certain amount of these sheets are then packaged. An interleave may be used to separate the sheets within the package.

The water vapour transmission rate (WVTR) of packaging material gives an indication of the diffusion of water vapour in and out the packaging.

The WVTR of the packaging for the separators according to the present invention is preferably less than 5 g/m²/24 hours, more preferably less than 2.5 g/m²/24 hours, most preferably less than 1 g/m²/24 hours, particularly preferred less than 0.5 g/m²/24 hours. However, the WVTR of the packaging may be less than 0.1 g/m²/24 hours or even less than 0.01 g/m²/24 hours

Any packaging material may be used having the WVTR values described above.

A typical packaging material comprises a barrier laminate prepared from different foils/materials, such as for example aluminium, polyethylene (PE), polyethylene terephthalate (PET), oriented polypropylene (OPP) or non-woven materials. Such a barrier laminate is typically provided on a core, such as cardboard.

A preferred barrier laminate is for example a PET/PE laminate, for example a PET/PE laminate of a 12 μm (+/−10%) PET foil and a 75 μm (+/−15%) PE foil. This barrier laminate is then preferably provided a cardboard, for example a 76 mm thick cardboard.

### Electrolyser

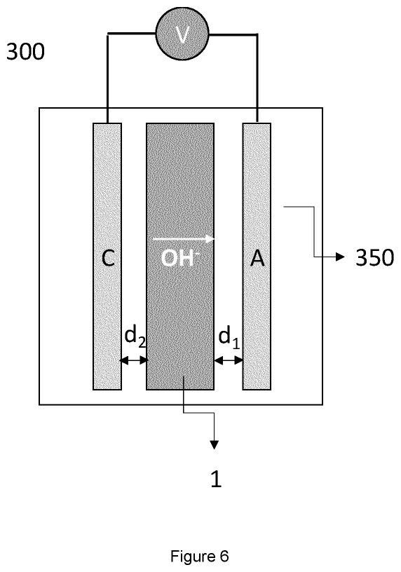

The alkaline water electrolysis according to the present invention is carried out using an electrolytic cell (300) as shown in FIG. 6 comprising a cathode (C), an anode (A), a separator (1) as described below and an electrolyte solution (350).

When electric current is supplied to the electrolysis cell, hydroxyl ions of the electrolyte are oxidized into oxygen at the anode and water is reduced to hydrogen at the cathode. The hydroxyl ions formed at the cathode migrate through the separator to the anode. The separator prevents mixing of the hydrogen and oxygen gases formed during electrolysis.

An electrolyte solution is typically an alkaline solution. Preferred electrolyte solutions are aqueous solutions of electrolytes selected from sodium hydroxide and potassium hydroxide. Potassium hydroxide electrolytes are often preferred due to their higher specific conductivity. The concentration of the electrolyte in the electrolyte solution is preferably from 20 to 40 wt %, relative to the total weight of the electrolyte solution.

The temperature of the electrolyte is preferably from 50° C. to 120° C., more preferably from 75° C. to 100° C., most preferably from 80 to 90° C. However, a higher temperature, for example at least 100° C., more preferably from 125 to 165° C. may result in a more efficient electrolysis.

An electrode typically includes a substrate provided with a so-called catalyst layer. The catalyst layer may be different for the anode, where oxygen is formed, and the cathode, where hydrogen is formed.

Typical substrates are made from electrically conductive materials selected from the group consisting of nickel, iron, soft steel, stainless steel, vanadium, molybdenum, copper, silver, manganese, platinum group elements, graphite, and chromium. The substrates may be made from an electrically conductive alloy of two or more metals or a mixture of two or more electrically conductive materials. A preferred material is nickel or nickel-based alloys. Nickel has a good stability in strong alkaline solutions, has a good conductivity and is relatively cheap.

A catalyst layer preferably includes nickel, cobalt, iron, and platinum group elements. The catalyst layer may include these elements as elemental metals, compounds (e.g. oxides), composite oxides or alloys made of multiple metal elements, or mixtures thereof. Preferred catalyst layers include plated nickel, plated alloys of nickel and cobalt or nickel and iron, complex oxides including nickel and cobalt such as LaNiO3, LaCoO3, and NiCo2O4, compounds of platinum group elements such as iridium oxide, or carbon materials such as graphene.

A particularly preferred catalyst layer comprises Raney Nickel. The Raney nickel structure is formed by selectively leaching aluminium or zinc from a Ni—Al or Ni—Zn alloy. Lattice vacancies formed during leaching result in a large surface area and a high density of lattice defects, which are active sites for the electrocatalytic reaction to take place.

Preferred porous electrodes and methods to prepare them are disclosed in for example EP-A 3575442, paragraphs 23 to 84.

The pore size of porous electrodes may have an influence on the electrolysis efficiency. For example, in EP-A 3575442 it is disclosed that preferred pore sizes of the porous electrodes are from 10 nm up to 200 nm.

The catalyst layer may also include organic substances such as polymers to improve the durability and the adhesion towards the substrate.

In a so-called zero gap electrolytic cell the electrodes are placed directly in contact with the separator thereby reducing the space between both electrodes. Mesh-type or porous electrodes are used to enable the separator to be filled with electrolyte and for efficient removal of the oxygen and hydrogen gases formed. It has been observed such zero gap electrolytic cells operate at higher current densities.

However, in such a zero gap electrolytic cell it has been observed that gas bubbles formed inside the separator may accumulate at the top of the separator. Such accumulation of gas bubbles at the top of the separator may result in a higher ionic resistance in that part of the cell. A temperature rise as a result of a less efficient cooling by the electrolyte in that area of the electrolysis cell may even result in burning of the separator.

It has been observed that introducing a small distance between one side of the separator and at least one electrode results in less accumulation of gas bubbles inside the separator. The distance between one side of the separator and the anode (d1) and the distance between the other side of the separator and the cathode (d2) may be the same or different.

The distance d1 and/or d2 is preferably from 50 up to 500 μm, more preferably from 100 up to 250 μm.

A so-called spacer may be used to realize the distance between the separator and the electrode.

Such a spacer is preferably hydrophilic to avoid adhesion of gas bubbles to the spacer (static water contact angle is 90° C. or lower, preferably 45° C. or lower).

Such a spacer preferably has an open structure to ensure rapid and sufficient evacuation of gas bubbles.

A typical alkaline water electrolyser include several electrolytic cells, also referred to stack of electrolytic cells.

Regarding the cell configuration, two types of electrolyzers are typically used.

A unipolar (or “tank-type”) electrolyzer consists of alternate positive and negative electrodes held apart by a separator. Positive electrodes are all coupled together in parallel, as are the negative electrodes, and the whole assembly is immersed in a single electrolyte bath (“tank”) to form a unit cell. A plant-scale electrolyzer is then built up by connecting these units electrically in parallel. The total voltage applied to the whole electrolysis cell is the same as that applied to the individual unit cells.

On the other hand, in a bipolar electrolyzer a metal sheet (or “bipole”) connects electrically adjacent cells in series. The electrocatalyst for the negative electrode is coated on one face of the bipole and that for the positive electrode of the adjacent cell is coated on the reverse face. In this case, the total cell voltage is the sum of the individual unit cell voltages. Therefore, a series-connected stack of such cells forms a module that operates at a higher voltage and lower current than the tank-type (unipolar) design. To meet the requirements of a large electrolysis plant, these modules are connected in parallel so as to increase the current.

Membrane Electrode Assemblies (MEA) can also be used in an electrolyser. Such MEAs are typically prepared by applying a separator, preferably without a reinforcing support, on at least one porous electrode. Such MEAs are for example disclosed in EP-A 2831312 (Agfa Gevaert), EP3277862 (De Nora) and WO2020/158719 (Nippon Shokubai). Such MEAs may also be used in the electrolysis method according to the present invention.

### EXAMPLES

### Measurements

### Residual Solvent

The residual solvent was determined using Thermal Desorption Gas Chromatography (TD-GC) on an 4 mm punch of a separator during 20 minutes at 220° C.

The residual solvent amount is expressed herein as wt % relative to the total dry weight of the separator. The dry weight of the separator was determined as follows: A 49 mm circular punch of the separator is dried with a Mettler moisture analyzer unit the weight is stable for at least 2 minutes.

### Shrinkage

A 20×20 cm sample of a separator is preconditioned for 10 minutes in water at room temperature. A dimension in the Machine Direction (L [MD]) and the Cross Direction (L [CD]) is then measured.

The Machine Direction is the direction wherein the separator is transported through the production apparatus. The Cross Direction is perpendicular to the MD.

The sample is then immersed for 15 minutes in water at 100° C. followed by a post-conditioning for 10 minutes in water at room temperature.

A dimension in in the Machine (L′ [MD]) and the Cross Direction (L′ [MD])) is then measured again.

The shrinkage in the Machine Direction (Shrink [MD]) and in de Cross Direction (Shrink [CD]), both as percentage, is then calculated using the Formula:

$$Shrink [ MD ] = \frac{L [ MD ] - {L}^{′} [ MD ]}{L [ MD ]} \times 100 \\ Shrink [ CD ] = \frac{L [ CD ] - {L}^{′} [ CD ]}{L [ CD ]} \times 100$$

Volume % Pores Filled with Water

A sample having a diameter of 49 mm is punched from a separator. The water content of the sample is measured by weighing the sample before (WA) and after (WB) drying. The sample is dried, for example with a Mettler moisture analyser, until the weight of the sample remains constant for at least 2 minutes.

The sample is then completely wetted in water by placing it in water having a temperature between 55 and 65° C. for 5 minutes. The weight of the completely wetted sample is then measured (WC).

The water content of the separator at the end of the preparation method just before packaging is WA-WB. The water content of a completely wetted separator is WC−WB.

The Volume % of pores filled with water (Vol % P) of a separator is then the ratio of the water content of the separator to the water content of the completely wetted separator (see Formula I).

$$Vol \% P = \frac{{W}_{A} - {W}_{B}}{{W}_{C} - {W}_{B}} \qquad Formula I$$

### Viscosity

The viscosities of the dope solutions at 100 s⁻¹ and 20° C. were measured with a Kinexus LAB+Rheometer available from Malvern Panalytical using a “Cup&Bob” geometry.

### Cracks

The cracks in the separators were determined using Scanning Electron Microscopy (SEM) on a cross section of the separator.

The amount of cracks were classified as:
No cracks=0
Some cracks=1
A lot of cracks=2

### Example 1

This examples illustrates the effect of a washing step on the residual solvent amount and its effect on the irreversible shrinkage of a separator.

### Preparation of the Separator S-1

The separator S-1 was prepared as schematically depicted in FIG. 4 using a dope solution comprising 10 wt % polysulfone, 40 wt % Zirconium oxide and 50 wt % N-butyl pyrrolidone (NBP) on a PPS fabric having a thickness of 300 μm.

The dope solutions were coated on both sides of the polymer fabric using slot die coating technology at a speed of 1 m/min.

The coated fabric was then transported towards a water bath kept at 65° C.

A VIPS step was carried out before entering the water bath in an enclosed area.

The coated support then entered the water bath for 6 minutes during which a liquid induced phase separation (LIPS) occurred.

The thickness of the obtained separator was approximately 500 μm.

After the phase inversion step the separator was passed through a water bath according to conditions shown in Table 1 (Washing step).

The residual solvent amount (NBP; wt % relative to the total dry weight of the separator) and the irreversible shrinkage of the obtained separators, determined as described above, are also shown in Table 1.

TABLE 1

| Washing Step | Residual NBP | Shrink [CD] |
|---|---|---|
| 60° C./15 min | 1.37 | 0.24 |
| 85° C./15 min | 1.04 | 0.12 |
| 85° C./30 min | 0.36 | 0.08 |

It is clear from the results of Table 1 that the residual solvent amount may be decreased by carrying out a washing step after the phase inversion step.

It is also clear from Table 1 that a lower residual solvent amount results in a lower irreversible shrinkage, in particular a lower irreversbile shrinkage in the cross direction.

### Example 2

This examples illustrates the effect of the residual solvent amount on the occurrence of cracks in a separator.

The amount of cracks of separators S-2 to S-5 prepared as described above using a washing step 60° C./15 min, the separators having a different amount of residual N-butyl pyrrolodine (NBP, wt % relative to the total dry weight of the separator) are shown in Table 2.

TABLE 2

| Separator | Residual NBP | cracks |
|---|---|---|
| S-2 | 1.67 | 0 |
| S-3 | 1.63 | 0 |
| S-4 | 2.40 | 1 |
| S-5 | 3.13 | 1 |

It is clear from the results of Table 2 that the amount of cracks increases when the residual solvent amount increases.

### Example 3

This example illustrates the effect of NBP present in the coagulation bath and/or washing bath step of the manufacturing method on cracks in the obtained separator.

Separators S-6 to S-11 were prepared as described in Example 1 wherein the separators were passed through a coagulation bath (CB) for 24 hours and a washing bath (WB), also for 24 hours, both baths having a NBP concentration (wt %) as shown in Table 3.

The residual NBP amount of the separators S-6 to S-11 (wt % relative to the total dry weight of the separator) and the amount of cracks observed in these separators, determined as described above, are shown in Table 3.

TABLE 3

| | [NBP] CB | [NBP] WB | Residual NBP | Cracks |
|---|---|---|---|---|
| S-6 | 10 | 0 | 1.15 | 0 |
| S-7 | 15 | 0 | 1.08 | 0 |
| S-8 | 20 | 0 | 1.08 | 0 |
| S-9 | 10 | 10 | 2.84 | 1 |
| S-10 | 15 | 15 | 2.31 | 1 |
| S-11 | 20 | 20 | 7.51 | 2 |

From the results of Table 3 it is clear that the number of cracks observed in the separators is correlated with the residual solvent amount.

1-15. (canceled)

16. A separator for an electrolytic cell characterized in that the separator has a residual non-aqueous solvent amount of less than 5 wt %, relative to the total dry weight of the separator.

17. The separator of claim 16, wherein the separator has an irreversible shrinkage, determined as described in the description, of 2.5% or less.

18. The separator of claim 16, comprising a porous support and a porous layer provided on the porous support.

19. The separator of claim 18, wherein the separator includes a first porous layer provided on one side of the porous support and a second porous layer provided on the other side of the porous support.

20. The separator of claim 18, wherein the porous layer includes a polymer and inorganic particles.

21. The separator of claim 20, wherein the polymer is selected from the group consisting of polysulfone, polyethersulfone, polyphenylenesulfone, polyether ether ketone, and polyphenylenesulfide.

22. The separator of claim 20, wherein the inorganic particles are selected from the group consisting of zirconium oxide, zirconium hydroxide, magnesium oxide, magnesium hydroxide, titanium oxide, titanium hydroxide, and barium sulfate.

23. The separator of claim 22, wherein the inorganic particles have a particle size D₅₀ of less than or equal to 0.7 μm.

24. The separator of claim 16, wherein a thickness of the separator is from 75 to 500 μm.

25. The separator of claim 18, wherein the porous support is a polymeric fabric selected from a polypropylene (PP), a polyphenylene sulphide (PPS), and a polyether ether ketone (PEEK) fabric.

26. The separator of claim 25, wherein the porous support has a thickness of less than or equal to 350 μm.

27. A method of manufacturing the separator of claim 18, the method comprising the steps of:
applying a dope solution comprising a polymer, inorganic particles, and a solvent on a side of a porous support;
performing phase inversion on the applied dope solution thereby forming a separator comprising a porous layer on the support; and
carrying out a washing step.

28. The method of claim 27, wherein the washing step is carried out in a water bath at a temperature of at least 60° C.

29. The method of claim 28, wherein the washing step is carried out for 10 to 60 minutes.

30. Use of a separator as defined in claim 16 in an electrolytic cell for the production of green hydrogen, green ammonia, or green steel.
